(19) United States
(12) Patent Application Publication
(10) Pub. No.: US 2002/0095805 A1
(43) Pub. Date: Jul. 25, 2002

(54) Tape rule blade having graduations in an eye-catching third color

(76) Inventor: Cheng-Hui Hsu, Hsin Tien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/765,570

(22) Filed: Jan. 22, 2001

(51) Int. Cl. G01B 3/02

(52) U.S. Cl. 33/494

(57) ABSTRACT

A tape rule blade having graduations in an eye-catching third color, wherein the numerals of the graduations on the tape rule blade are in numeric characters of a first color, numeric characters of a second color, and numeric characters of the eye-catching third color to facilitate the visual separation of adjacent numeric characters. At the same time, the alerting effect also afforded prevents sighting errors and reading inaccuracies, with the tape rule blade thereby having even more practical value through an innovative design.

### BACKGROUND OF THE INVENTION

1) Field of the Invention

The invention herein relates to a tape rule blade having graduations in an eye-catching third color in which designated inch positions of the tape rule blade are in an eye-catching third color along the graduations to facilitate visual separation and afford an alerting effect that prevents sighting errors and reading inaccuracies, with the tape rule blade thereby having even more practical value through an innovative design.

2) Description of the Prior Art

With the blade graduations of a conventional tape rule, as indicated in FIG. 1, the said conventional tape rule blade 10 has the numerals of its graduations consisting of black numeric characters A and, at whole number areas such as 1 inch (or 12 inches), the graduation numerals consist of red numeric characters B; since the conventional tape rule blade graduations are only in numeric characters of two colors, sighting errors and inaccurate readings frequently occur during the utilization process; in view of the shortcomings of such conventional tape rule blade graduations that await improvement, the inventor of the invention herein conducted extensive research and improvement which culminated in the successful development of a tape rule blade having graduations in an eye-catching third color that thereby overcomes the drawbacks of the conventional product.

### SUMMARY OF THE INVENTION

The primary objective of the invention herein is to provide a tape rule blade having graduations in an eye-catching third color, wherein designated inch positions of the tape rule blade are in an eye-catching third color along the graduations to facilitate visual separation while also affording an alerting effect that prevents sighting errors and reading inaccuracies, with the tape rule blade thereby having even more practical value through an innovative design.

To enable the examination committee to further understand the innovative features as well as the advantages of the invention herein, the embodiments thereof are accompanied by the brief description of the drawings below and followed by the detailed description of the invention.

### BRIEF DESCRIPTION OF THE DRAWINGS

FIG. 1 is an orthographic drawing of a conventional product.

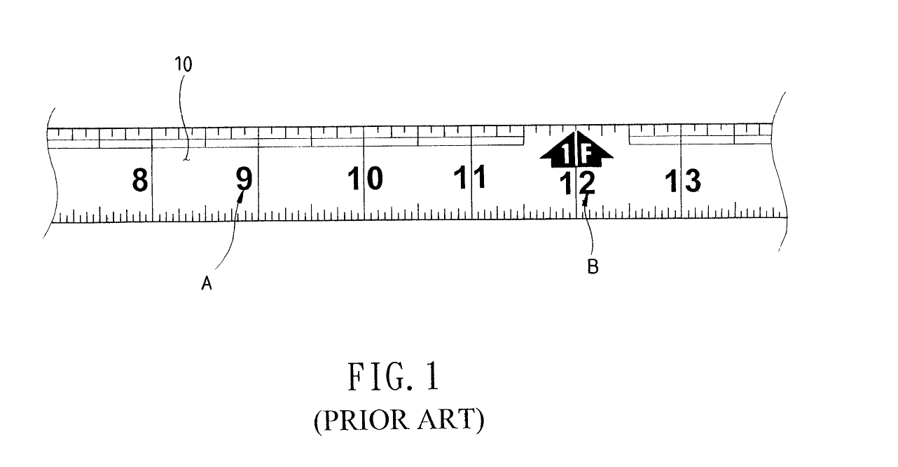

FIG. 2 is an orthographic drawing of the invention herein.

FIG. 3 is an orthographic drawing of the invention herein.

FIG. 4 is an orthographic drawing of the invention herein.

### DETAILED DESCRIPTION OF THE INVENTION

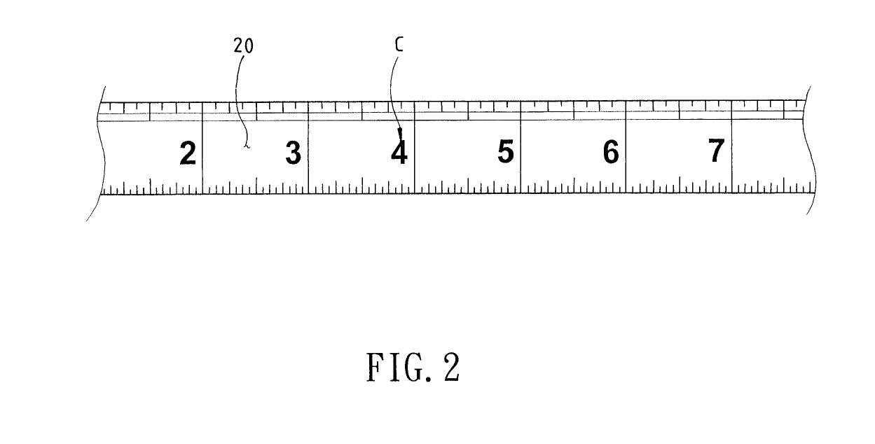

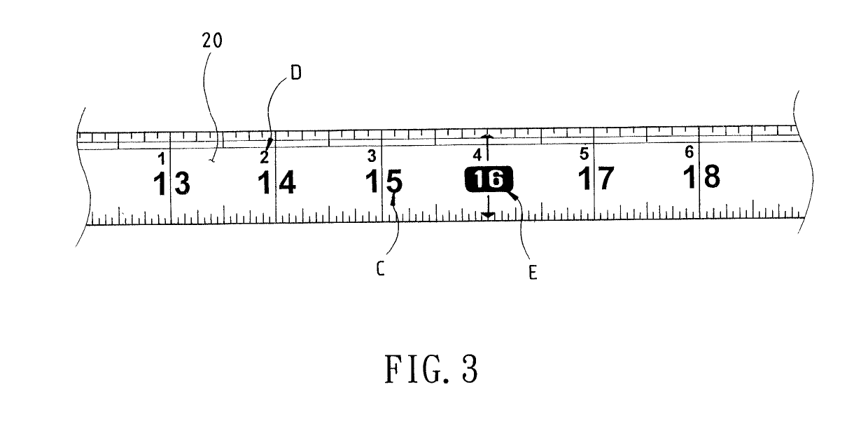

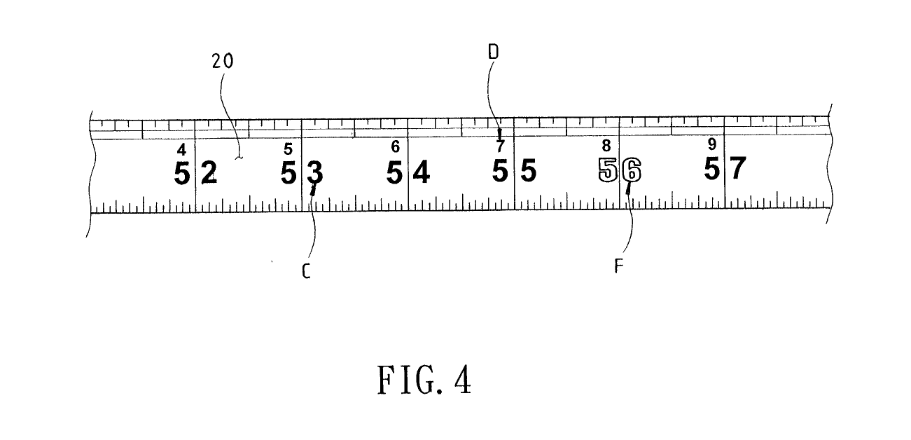

Referring to FIG. 2, the numerals (1, 2, 3, . . . etc.) of the graduations on the said tape rule blade 20 are situated at every inch in numeric characters of a first color C; as indicated in FIG. 3, the numerals (13, 14, 15, . . . etc.) of the graduations on the said tape rule blade 20 are also situated at every inch in numeric characters of the first color C, but at the upper extent of the said numeric characters of the first color C and rendered with a smaller font are numerals (1, 2, 3, . . . etc.) in numeric characters of a second color D; furthermore, numerals situated at consecutive multiples of 16 inches (16, 32, 48, 64 . . . etc.) are in hollow numeric characters of the second color E; as indicated in FIG. 4, the numerals (52, 53, 54, . . . etc.) of the graduations on the said tape rule blade 20 are situated at every inch in numeric characters of the first color C; at the upper extent of the numeric characters of the first color C and rendered with a smaller font are numerals (1, 2, 3, . . . etc.) in numeric characters of the second color D; and the numerals at the 56-inch graduation and other special positions are rendered with an outline font in numeric characters of a third color F.

The said special positions in the numeric characters of the third color F on the tape rule blade 20 of the invention herein include the numerals at the graduations of 56 inches, 65 inches, 96 inches, 156 inches, 165 inches, 169 inches, 196 inches, 256 inches, 265 inches, 269 inches, and 296 inches.

The structure of the invention herein is capable of achieving the claimed applications and performance, however the preceding description of the most preferred embodiment of the invention herein only serves as a disclosure of the innovative features of the present invention and shall not be construed as a limitation on any rights and benefits of the invention herein and, furthermore, all changes to the colors of the graduations as well as substitutions of numeric characters shall remain within the scope and claims of the invention herein.

In summation of the foregoing section, since the tape rule blade having graduations in an eye-catching third color of the invention herein is capable of achieving its objectives and applications and possesses exceptional practical value and, furthermore, an identical or similar article has never been disclosed on the market, the invention herein is submitted to the examination committee for review and the granting of the commensurate patent rights.

1. A tape rule blade having graduations in an eye-catching third color, wherein the numerals of the graduations on the said tape rule blade are in numeric characters of a first color, numeric characters of a second color, and numeric characters of an eye-catching third color to facilitate the visual separation of adjacent numeric characters.

2. As mentioned in claim 1 of the tape rule blade having graduations in an eye-catching third color of the invention herein, the numerals of the graduations on the said tape rule blade situated at consecutive multiples of 16 inches (16, 32, 48, 64 . . . etc.) are in the said numeric characters of the second color and, furthermore, special positions including the numerals at the graduations of 56 inches, 65 inches, 96 inches, 156 inches, 165 inches, 169 inches, 196 inches, 256 inches, 265 inches, 269 inches, and 296 inches are in the said numeric characters of the eye-catching third color, with the remaining numerals (1, 2, 3 . . . and 298, 299, 300 . . . etc.) situated at other individual inch graduations consisting of the said numeric characters in the first color.
